(19) United States
(12) Patent Application Publication
(10) Pub. No.: US 2008/0041200 A1
(43) Pub. Date: Feb. 21, 2008

(54) METHOD AND APPARATUS FOR FEEDING BARS INTO A CUTTING LATHE

(76) Inventor: William C. Kneebusch, Valley City, OH (US)

Correspondence Address: BROUSE MCDOWELL LPA, 388 SOUTH MAIN STREET, SUITE 500, AKRON, OH, 44311, US

(21) Appl. No.: 11/677,882

(22) Filed: Feb. 22, 2007

Related U.S. Application Data
(60) Provisional application No. 60/775,566, filed on Feb. 22, 2006.

(51) Int. Cl. B23B 13/00

(52) U.S. Cl. 82/1.11; 82/127

(57) ABSTRACT

A new and improved bar feeder is herein disclosed. A bar feeder for use with an associated cutting lathe includes a guide rail, an air motor, at least four supports, each of the supports comprising a top, a base, a bushing, the bushing having a centerline opening, wherein the bushing can rotate freely in relation to the support, at least four drive gears, wherein each of the at least four supports is operatively connected to the drive gear, wherein the at least four supports are linked together, wherein the supports can be adjusted horizontally along the guide rail, a gear rack, the at least four drive gears operatively connected to the gear rack, and a pressurized cylinder for pushing an associated bar into the associated cutting lathe.

This application claims priority to a provisional patent application entitled METHOD AND APPARATUS FOR FEEDING BARS INTO A CUTTING LATHE, Ser. No. 60/775,566, filed Feb. 22, 2006.

### 1. BACKGROUND OF THE INVENTION

A. Field of Invention

This invention pertains to the art of cutting lathes, and more particularly to feeding bars into a cutting lathe.

B. Description of the Related Art

The present invention provides a machine for feeding bars into a cutting lathe, encompassing a linear rail running parallel with the centerline of the spindle upon which is mounted at least one radial support bushing. The difficulties inherit in the art are therefore overcome in a way that is simple and efficient, while providing better and more advantageous results.

In the United States, bar stock typically comes in twelve foot lengths, and is typically fed into a cutting lathe with a rotation of 3000 rpm to 10,000 rpm. When metal bar stock is placed onto a bar feeder to be fed into a cutting lathe, the bar stock is rotated at a high rate of speed. Vibrations from the rotation can cause imperfections in the cutting, which, if the material needs a smooth microfinish, can cause significant problems. Currently, the process utilizes a housing with high viscosity oil running through the housing to absorb bar vibration. With the hydrodynamic bar feeders, the fluid encapsulates the bar in a tube. Another issue is remnant retract, wherein any remnants of the bar are removed from the feeder. Currently, the remnant is removed from the feeder by a claw that grabs the bar and pulls it back through the feeder.

Currently, another process utilizes a housing that is supported by either a bushing or a tube.

### II. DEFINITIONS

Bearing—an object, surface, or point that supports a machine part in which another part (as a journal or pin) turns or slides.

Bushing—a usually removable lining for an opening (as of a mechanical part) used to limit the size of the opening, resist abrasion, or serve as a guide.

### III. SUMMARY OF THE INVENTION

In accordance with one aspect of this invention, a linear rail, or multiple rails, runs parallel with the centerline of the spindle upon which is mounted at least one, but typically four, radial support bushing.

In accordance with another aspect of the invention, the bushings are mounted within a housing that rides on the rails.

In accordance with another aspect of the invention, the radial support bushings have the ability to slide in the housing along the rail(s) so as to compensate and adjust spacing for bar consumption.

In accordance with another aspect of the invention, the bushing moves along a rail, which enables a bar to be automatically loaded.

In accordance with another aspect of the invention, a bar feeder for use with an associated cutting lathe includes a guide rail, an air motor, at least four supports, each of the supports comprising a top, a base, a bushing, the bushing having a centerline opening, wherein the bushing can rotate freely in relation to the support, at least four drive gears, wherein each of the at least four supports is operatively connected to the drive gear, wherein the at least four supports are linked together, wherein the supports can be adjusted horizontally along the guide rail, a gear rack, the at least four drive gears operatively connected to the gear rack, and a pressurized cylinder for pushing an associated bar into the associated cutting lathe.

In accordance with another aspect of the invention, a bar feeder for use with an associated cutting lathe includes a guide rail, a motor, multiple supports, each of the supports comprising a top, a base, a bushing, wherein the bushing can rotate freely in relation to the support, at least one drive gear, wherein at least one of the supports is operatively connected to the drive gear, wherein the supports can be adjusted horizontally along the guide rail, and a gear rack, the at least one drive gear operatively connected to the gear rack.

In accordance with another aspect of the invention, the internal diameter of the bushing is self adjusting.

In accordance with another aspect of the invention, the bushing has an opening.

In accordance with another aspect of the invention, the bar feeder further includes at least two drive gears, wherein each of the supports is operatively connected to the drive gear.

In accordance with another aspect of the invention, the bar feeder further includes a pressurized cylinder for pushing an associated bar into the associated cutting lathe.

In accordance with another aspect of the invention, the motor is an air motor.

In accordance with another aspect of the invention, the bushing further includes two plates, a first rubber insert, the first insert being located between the plates, the first rubber insert having a opening slit, and a second rubber insert, the second insert being located between the plates, the second rubber insert having a opening slit which is rotated with respect to the opening slit of the first rubber insert.

In accordance with another aspect of the invention, the opening slit of the second rubber insert is rotated between one degree and one hundred seventy-nine degrees with respect to the opening slit of the first rubber insert.

In accordance with another aspect of the invention, the opening slit of the second rubber insert is rotated between forty-five degrees and ninety degrees with respect to the opening slit of the first rubber insert.

In accordance with another aspect of the invention, the opening slit of the second rubber insert is rotated ninety degrees with respect to the opening slit of the first rubber insert.

In accordance with another aspect of the invention, the bushing is held rotatably in place by at least three bearings and the support has a removable top such that the bushing is removable.

In accordance with another aspect of the invention, the supports are linked together, wherein the supports can be adjusted horizontally along the guide rail.

In accordance with another aspect of the invention, the supports are linked together by a stretchable coil.

In accordance with another aspect of the invention, the supports are linked together by a chain.

In accordance with another aspect of the invention, a method for feeding a bar into a cutting lathe, wherein a bar feeder has a guide rail, a motor, multiple supports, each of the supports comprising a top, a base, and a bushing, wherein the bushing can freely rotate in relation to the support, at least one drive gear, wherein at least one of the supports is operatively connected to the drive gear, a gear rack, the at least one drive gear operatively connected to the gear rack, includes the steps of turning on the motor, inserting a bar into the bar feeder and through each of the bushings, maintaining a constant pressure on the bushings, and pushing the bar through the bar feeder with a pressurized cylinder.

In accordance with another aspect of the invention, the method further includes adjusting the horizontal position of at least one of the supports along the guide rail.

In accordance with another aspect of the invention, the method further includes pushing a remnant out of the front of the cutting lathe.

In accordance with another aspect of the invention, the method further includes opening the top of the support, removing the bushing, and inserting a new bushing.

The present invention allows for dampening vibrations in the bar without the need for additional lubrication.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein the various figures show the inventive system with its various parts and the way in which they connect.

FIG. 1 shows a perspective view of a prior art bar feeder and lathe;

FIG. 1A shows a perspective view of a prior art bearing;

FIG. 2 shows a perspective view of the inventive bar feeder and lathe;

FIG. 3 shows a perspective view of the guide rail and supports;

FIG. 3A shows a perspective view of the guide rail and supports with a stretchable coil between the supports;

FIG. 4 shows a perspective view of one embodiment of the bushing;

FIG. 5 shows a perspective view of one embodiment of the bushing with a removable housing;

FIG. 6 shows a perspective view of rubber inserts;

FIG. 7 shows a top view of the inventive bar feeder;

FIG. 8 shows a top view of the inventive bar feeder with a pressurized cylinder; and,

FIG. 9 shows a perspective view of another embodiment of the bushing with inserts.

### IV. DESCRIPTION OF THE INVENTION

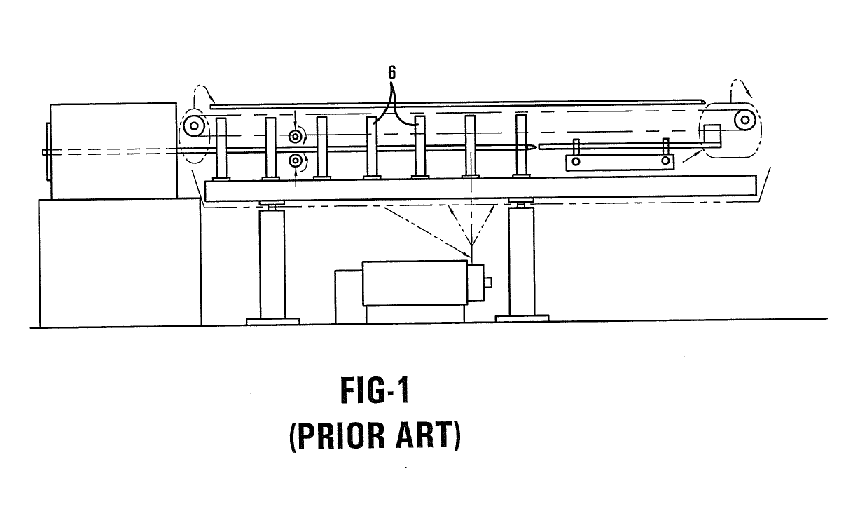

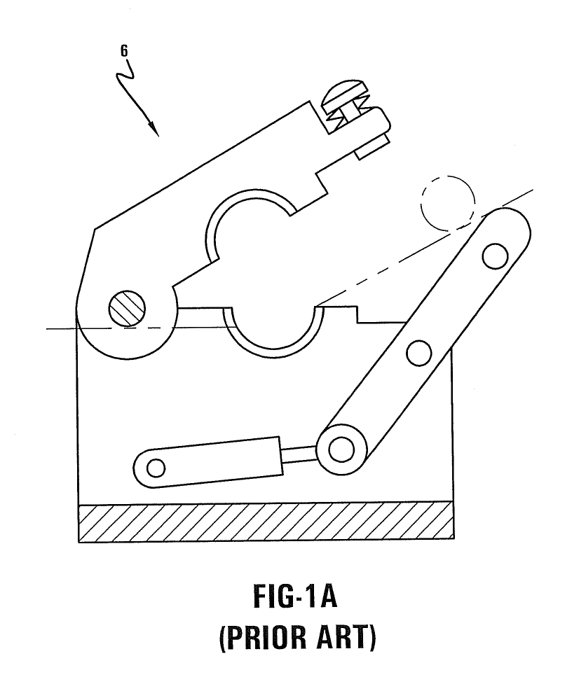

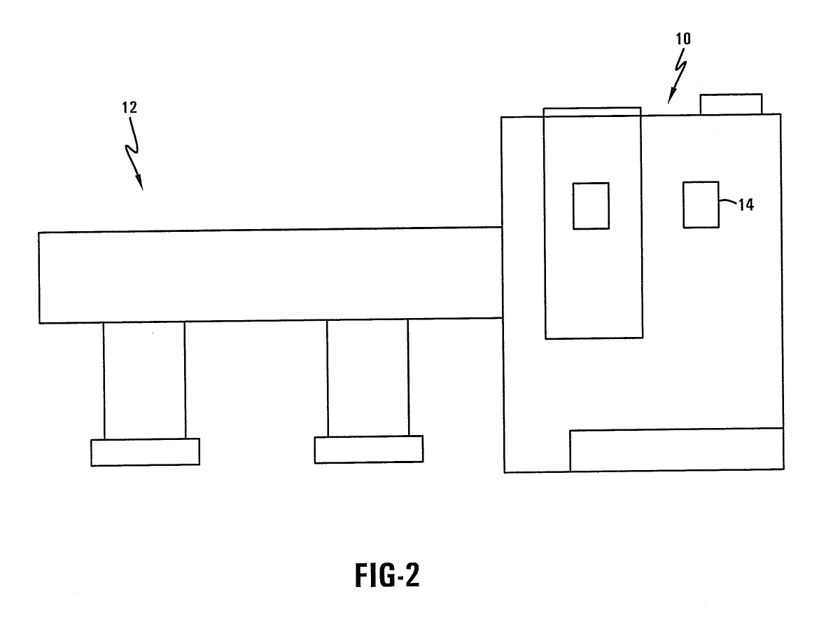

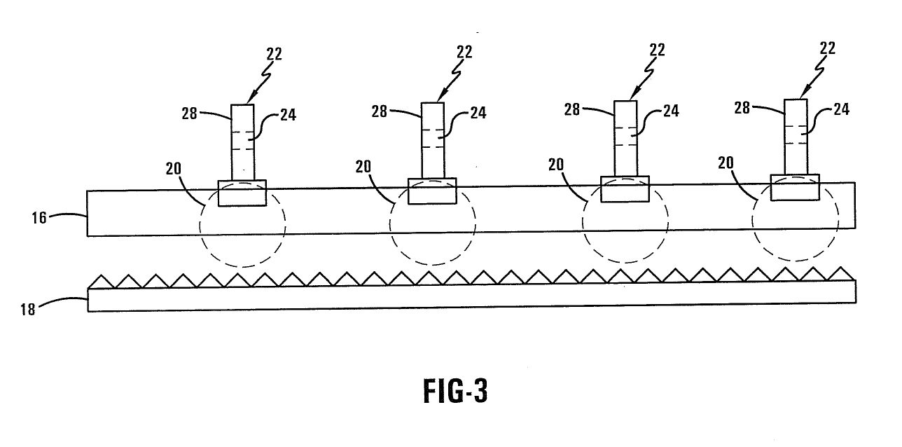

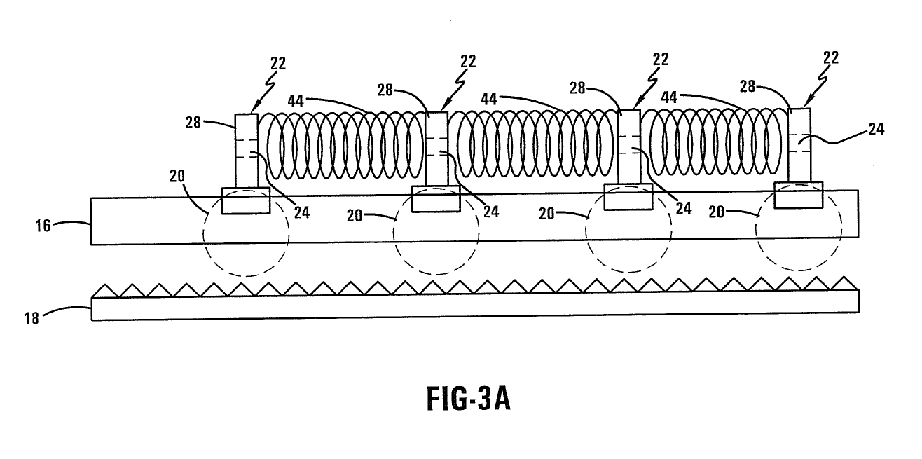

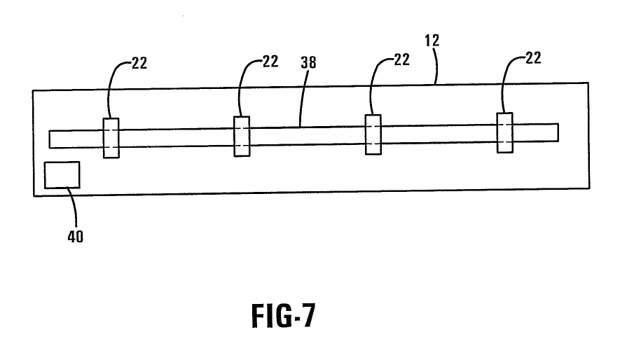

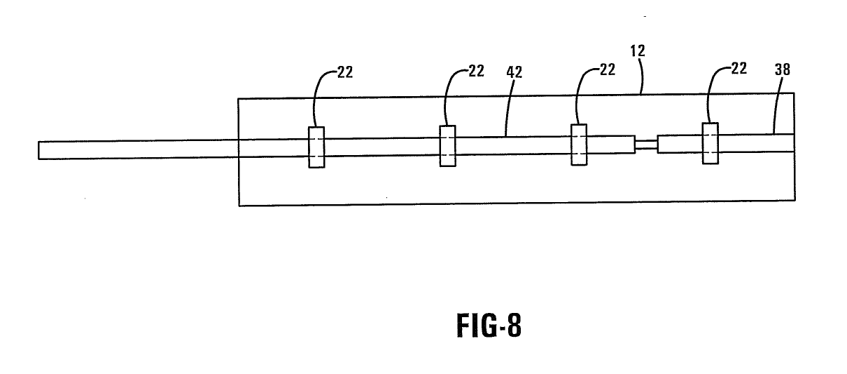

Referring now to the drawings wherein the showings are for purposes of illustrating at least one embodiment of the invention only and not for purposes of limiting the same, FIG. 1 shows a prior art lathe or turning center with a bar loader loading a bar into the lathe. FIG. 1A shows a prior art bearing unit 6. FIGS. 2-8 show the inventive bar feeder 12, which includes guide rail 16, gear rack 18, drive gear 20, support 22, bushing 24, bearing 26, housing top 28, bushing opening 30, removable top 32, horizontal opening 34, vertical opening 36, bar 38, motor 40, cylinder 42, and coil 44.

With continuing reference to FIGS. 2-8, in one embodiment, five supports 22 are spaced along the guide rail 16. The supports have a top 28, a base (shown, but not referenced), and a bushing 24. The supports 22 are operatively connected to the guide rail, and a drive gear 20 operatively connects the support 22 to a gear rack 18. The drive gear 20 and gear rack 18 allow the supports 22 to move along the guide rail 16. The bushing 24 is located within the support 22 and, in one embodiment, can freely rotate within the support 22. By “freely rotate” it is meant that the bushing 24 can rotate about a horizontal axis while the support 22 is stationary. The design and operation of the cutting lathe 10 are well known in the art, and will not be described further herein.

In one embodiment of the invention, the support 22 adjusts for bar 38 consumption by spacing tighter together. The support 22 can also split or moved to one end to allow a bar 38 to be oriented/positioned to the bushing 24. The drive gear 20 is attached to the support 22 by a motor (not shown). The bar 38 spins in an open bearing design, rubber-lined bushing 24. Although in this embodiment, the bushing 24 is lined with rubber, it is to be understood that any material could be used, as long as chosen using sound engineering judgment.

With continuing reference to FIGS. 2-8, the inventive process includes, in one embodiment, turning on the air motor 40 and feeding the bar 38 into the bar feeder 12. The use of an air motor 40 allows the bar feeder 12 to always be in ready mode for feeding the bar 38. Other types of motors 40 are contemplated by this invention, but would require a clutch mechanism to operate. The use of an air motor 40 requires no bar feed interface, because air is used to feed the bar 38, the feeder 12 is always in ready mode. In this embodiment, the air pressure on the air motor 40 can be adjusted as necessary. Once the bar 38 is fed into the feeder 12, the supports 22 and bushings 24 can be adjusted as necessary depending on the type of part and the operation needed. The bushings 24 can either be fixed, self-adjusting, or manually adjustable. In the embodiment in which the bushings 24 are adjustable, the same bushings 24 can be used for different diameter bars 38. In one embodiment, the supports 22 are linked together with a central drive (not shown). The supports 22 can be linked in any manner chosen using sound engineering judgment. One embodiment of the linking could be a stretchable coil 44 that could expand and contract as the supports 22 moved along the guide rail 16. The number of bushings that can be used in this embodiment is 2, 3, 4, 5, 6, 7, 8, 9, 10, or more.

In one embodiment, the bar 38 is pushed through the bar feeder 12 into the lathe 10 by a pressurized cylinder 42. The cylinder 42 has a diameter to allow it to pass through the bushings 24. In the course of producing parts with a lathe 10, typically there is a remnant of the bar 38 which is not used. In this embodiment, the cylinder 42 pushes the remnant out the front of the feeder 12, instead of a remnant retract system. With a remnant retract system, the bushings need to be sized to allow space for a claw to grab the remnant. In one embodiment of the present invention, the bushings 24 are sized for the bar and the remnant is pushed out.

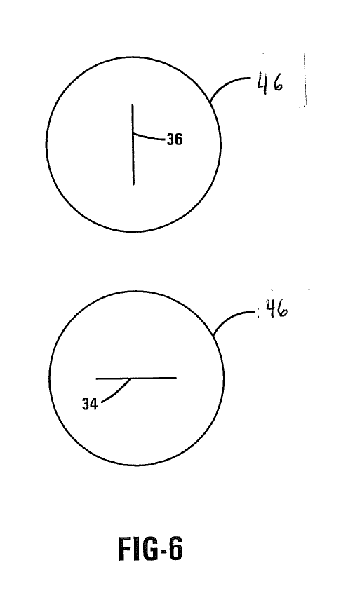

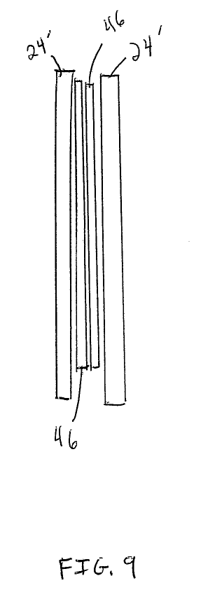

In another embodiment of the invention, as shown in FIGS. 6 and 9, the bushing 24′ could have two rubber inserts 46. In this embodiment, the bushing 24′ would consist of two plates 24′, with the rubber inserts 46 located between the plates 24′. The first insert 46 has a horizontal slit 34 and the second insert 46 has a vertical slit 36. When the bar 38 is pushed through the inserts 46, the bar 38 is held in place, but the flexible material of the insert 46 allows for rotation of the bar 38. In this embodiment, the slits 34, 36 are rotated ninety degrees with respect to each other (90°). However, it is to be understood that other angles of rotation can be used, as long as chosen using sound engineering judgment. In this embodiment, the inserts 46 would allow for a remnant retract system to be used.

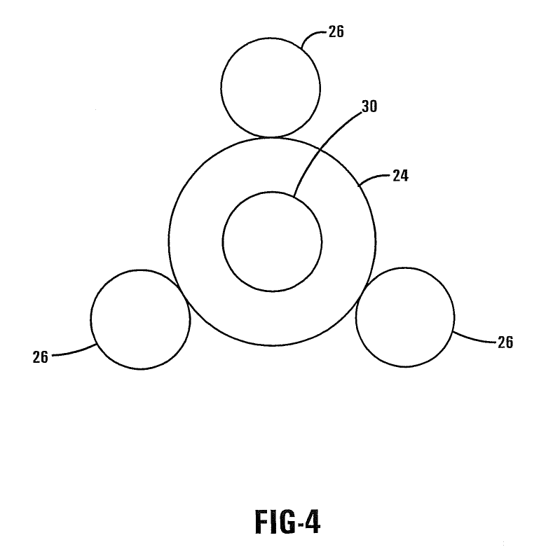

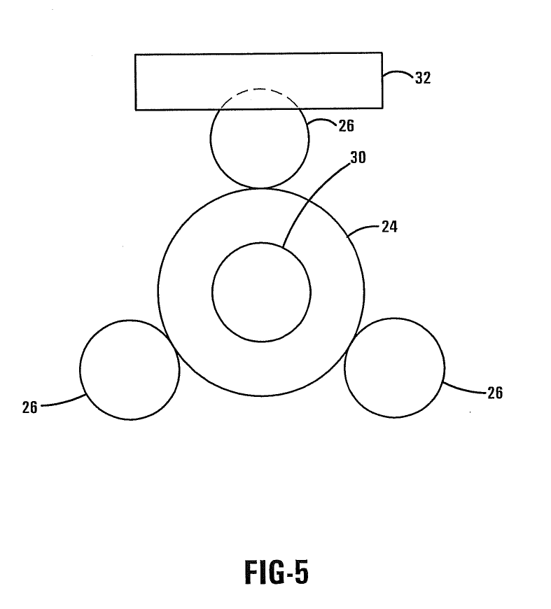

In another embodiment of the invention, as shown in FIGS. 4 and 5, the bushing 24 is held in place by bearings 26, wherein the bearings 26 approximately form a triangle around the bushing 24. This allows for easy rotation of the bushing 24 within the support 22. In another embodiment, the removable top 32 of the support 22 can be opened for easy interchange of bushings 24.

It is to be understood that any number of bushings and/or supports can be used with this invention, as long as chosen with sound engineering judgment. It is also to be understood that the material used for the supports and bushings is not critical to this invention, and any material can be used, as long as chosen using sound engineering judgment. It is also to be understood that although drive gears and a gear rack are mentioned, any type of mechanism can be used to move the supports along the guide rails, as long as chosen using sound engineering judgment.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

I/We claim:

1. A bar feeder for use with an associated cutting lathe, the bar feeder comprising:
a guide rail;
an air motor;
at least four supports, each of the supports comprising:
a top;
a base;
a bushing, the bushing having a centerline opening, wherein the bushing can rotate freely in relation to the support;
at least four drive gears, wherein each of the at least four supports is operatively connected to the drive gear, wherein the at least four supports are linked together, wherein the supports can be adjusted horizontally along the guide rail;
a gear rack, the at least four drive gears operatively connected to the gear rack; and,
a pressurized cylinder for pushing an associated bar into the associated cutting lathe.

2. A bar feeder for use with an associated cutting lathe, the bar feeder comprising:
a guide rail;
a motor;
multiple supports, each of the supports comprising:
a top;
a base;
a bushing, wherein the bushing can rotate freely in relation to the support;
at least one drive gear, wherein at least one of the supports is operatively connected to the drive gear, wherein the supports can be adjusted horizontally along the guide rail; and,
a gear rack, the at least one drive gear operatively connected to the gear rack.

3. The bar feeder of claim 2, wherein the internal diameter of the bushing is self adjusting.

4. The bar feeder of claim 2, wherein the bushing has an opening.

5. The bar feeder of claim 4, wherein the bar feeder further comprises:
at least two drive gears, wherein each of the supports is operatively connected to the drive gear.

6. The bar feeder of claim 5, wherein the bar feeder further comprises:
a pressurized cylinder for pushing an associated bar into the associated cutting lathe.

7. The bar feeder of claim 6, wherein the motor is an air motor.

8. The bar feeder of claim 2, wherein the bushing further comprises:
two plates;
a first rubber insert, the first insert being located between the plates, the first rubber insert having a opening slit; and,
a second rubber insert, the second insert being located between the plates, the second rubber insert having a opening slit which is rotated with respect to the opening slit of the first rubber insert.

9. The bar feeder of claim 8, wherein the opening slit of the second rubber insert is rotated between one degree and one hundred seventy-nine degrees with respect to the opening slit of the first rubber insert.

10. The bar feeder of claim 9, wherein the opening slit of the second rubber insert is rotated between forty-five degrees and ninety degrees with respect to the opening slit of the first rubber insert.

11. The bar feeder of claim 10, wherein the opening slit of the second rubber insert is rotated ninety degrees with respect to the opening slit of the first rubber insert.

12. The bar feeder of claim 2, wherein the bushing is held rotatably in place by at least three bearings and the support has a removable top such that the bushing is removable.

13. The bar feeder of claim 2, wherein the supports are linked together, wherein the supports can be adjusted horizontally along the guide rail.

14. The bar feeder of claim 13, wherein the supports are linked together by a stretchable coil.

15. The bar feeder of claim 14, wherein the supports are linked together by a chain.

16. A method for feeding a bar into a cutting lathe, wherein a bar feeder has a guide rail, a motor, multiple supports, each of the supports comprising a top, a base, and a bushing, wherein the bushing can freely rotate in relation to the support, at least one drive gear, wherein at least one of the supports is operatively connected to the drive gear, a gear rack, the at least one drive gear operatively connected to the gear rack, the method comprising the steps of:
turning on the motor;
inserting a bar into the bar feeder and through each of the bushings;
maintaining a constant pressure on the bushings; and,
pushing the bar through the bar feeder with a pressurized cylinder.

17. The method of claim 16, wherein the method further comprises the step of:
adjusting the horizontal position of at least one of the supports along the guide rail.

18. The method of claim 16, wherein the method further comprises the step of:
pushing a remnant out of the front of the cutting lathe.

19. The method of claim 16, wherein the method further comprises the steps of:
opening the top of the support;
removing the bushing; and,
inserting a new bushing.

20. The method of claim 16, wherein the supports are linked together.
